(19) United States
(12) Patent Application Publication
(10) Pub. No.: US 2008/0101056 A1
(43) Pub. Date: May 1, 2008

(54) COMBINATION MUG WITH FLASHLIGHT

(76) Inventor: DILIP BHAVNANI, Beverly Hills, CA (US)

Correspondence Address: THE SONI LAW FIRM, 55 S. LAKE AVE SUITE 720, PASADENA, CA, 91101, US

(21) Appl. No.: 11/555,276

(22) Filed: Oct. 31, 2006

(51) Int. Cl. F21V 33/00

(52) U.S. Cl. 362/101

(57) ABSTRACT

A liquid container having a handle for carrying the container. The container has a liquid container housing configured to selectively engage the handle. The handle has a hand-holdable handle housing and a light source embedded within the handle housing and being oriented therewithin to direct light outwardly therefrom. The handle also has an electrical lighting apparatus including an electrical circuit and a power source electrically connected to the electrical circuit, the electrical circuit being enclosed within the handle housing, the lighting apparatus being configured to illuminate the light source when the circuit is closed. The handle also has a switch disposed on the handle housing and in electrical communication with the electrical circuit and positionable between first and second positions for selectively closing and opening the circuit respectively. The handle also has an attachment mechanism configured to removably engage the liquid container housing at solely one location thereon.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The field of the present invention is handles for carrying objects such as beverage containers wherein the handle has an illuminating feature.

When engaged in activities such as camping, the need for lighting often arises. Flashlights can be used for this purpose. However, carrying a flashlight can be cumbersome and can take up limited space in a backpack or vehicle. Objects that serve other purposes are also necessary during such activities. For example, a beverage container is an important accessory.

Combining a lighting device with another necessary object thus becomes advantageous to better utilize limited space and to free up a hand for activity other than carrying two objects.

Prior art inventions attempted to resolve this problem by simply combining a flashlight with a beverage container, but these inventions suffer from several deficiencies. For example, U.S. Pat. No. 4,656,566 issued to Kelley discloses a combination flashlight/handle attachment for a thermos bottle. A standard flashlight is adapted with straps that attach to the thermos bottle to provide illumination from the flashlight and to provide the thermos with a handle. Disadvantageously, the configuration of the light source requires the thermos to be positioned in a horizontal configuration to use the flashlight effectively. Thus, such art appears to be limited to closed containers and the use of the flashlight with a standard tumbler mug or other open top liquid container would not appear to be possible. Moreover, Kelley appears to anticipate that the flashlight will not need to be removed from the thermos, since the thermos and flashlight can each be used independently of each other, and therefore uses straps to restrain the flashlight against the thermos in a somewhat permanent fashion. These straps are somewhat difficult to remove and such a design is not conducive to quick-release when necessary.

Similarly, U.S. Pat. No. 4,754,379 issued to Kelley appears to suffer from the same disadvantages and particularly suffers from the disadvantage that the thermos must be oriented in a horizontal position to operate the light source effectively.

U.S. Pat. No. D460,895 and U.S. Pat. No. 6,450,363 both issued to Lin disclose the use of interchangeable components with coffee mugs. Disadvantageously, the attaching a handle to the coffee mug requires the use of a circular ring which increases manufacturing costs. The Lin patents appear to have the objective of customizing the appearance of the mug but there does not appear to be any way for lighting circuitry to be used therein.

There is thus a need for a combined article that provides both a lighting device and fulfills another necessary function such as a flashlight in a manner that allows for removability of the same.

### BRIEF SUMMARY OF THE INVENTION

In accordance with a preferred embodiment of the present invention, there is provided a novel device for using and carrying an object such as a mug or other beverage container, wherein the handle also functions as a lighting device. The device has an attachment mechanism which permits alternative use as a carrying handle or a light when detached from the object.

In one embodiment of the present invention, the attachment mechanism can attach to the container solely in one location to provide ease of attachment and to minimize potential mechanical breakdown of the attachment mechanism. A further benefit of this feature is the reduction of the number of necessary parts.

The attachment mechanism can be located between the object and a housing of the handle which is gripped during use. This construction minimizes the necessary size of the attaching mechanism and also facilitates ease of use.

The handle of the present invention also includes a light source positioned to provide illumination from the housing. It further has an electrical apparatus including electrical circuitry and a power source. Finally, the invention includes a switch for turning the light source on and off.

Advantageously, the flashlight portion may be attached to a standard coffee mug with an open top and may be removed therefrom to use the flashlight. Preferably, the flashlight's light source is concealed when the handle/flashlight portion is engaged to the coffee mug housing so as to protect the light source when not in use.

### BRIEF DESCRIPTION OF THE DRAWINGS

FIG. 1 illustrates a front side top perspective view of a liquid container having the handle attached thereto and made according to the present invention;

FIG. 2 illustrates a back elevational view of a liquid container having the handle attached thereto and made according to the present invention;

FIG. 3 illustrates a front elevational view of a liquid container and made according to the present invention;

FIG. 4 illustrates a top plan view of a liquid container having the handle attached thereto and made according to the present invention;

FIG. 5 illustrates a back elevational view of a liquid container having the handle attached thereto and made according to the present invention;

FIG. 5A illustrates an exploded view of a first embodiment of a liquid container having the handle detached therefrom according to the present invention;

FIG. 5B illustrates an exploded view of a second embodiment of a liquid container having the handle detached therefrom according to the present invention;

FIG. 6 illustrates a bottom plan view of a liquid container having the handle attached thereto and made according to the present invention; and

FIG. 7 illustrates a perspective view of a handle made according to the present invention.

### DETAILED DESCRIPTION OF THE INVENTION

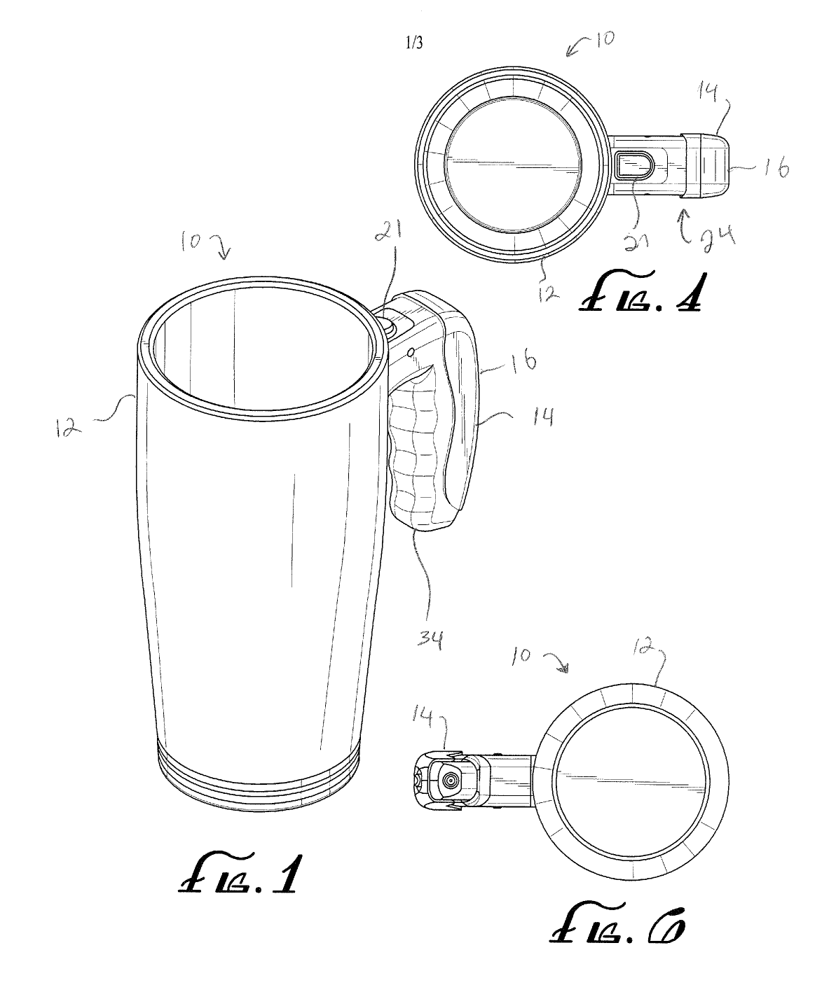

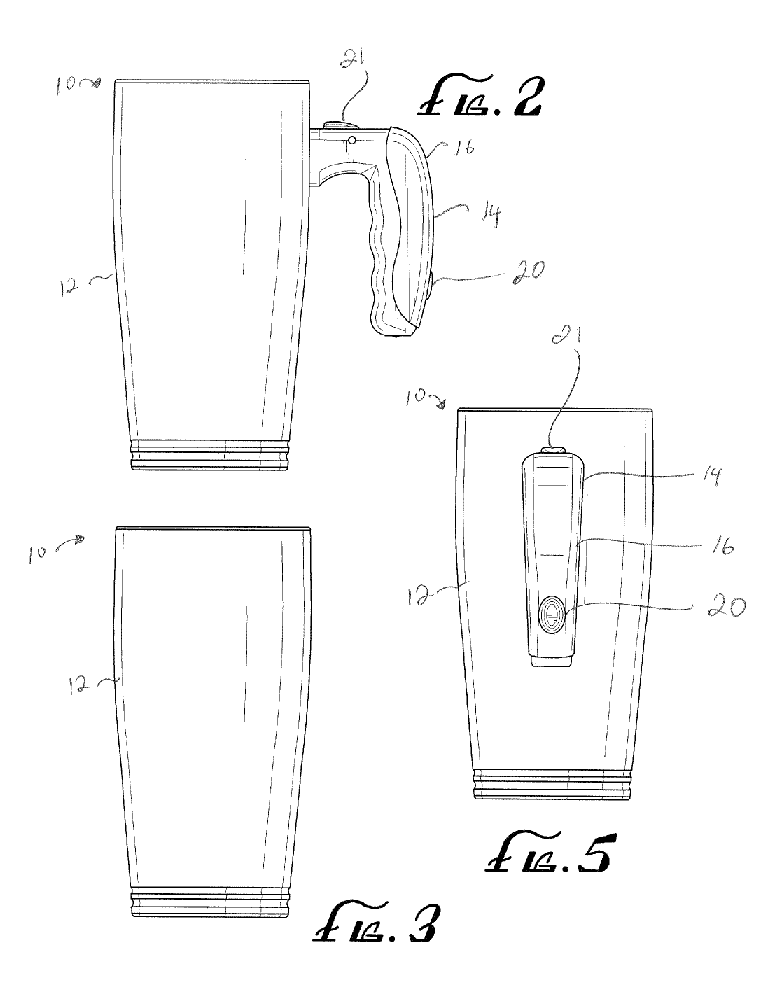

Referring now to the drawings wherein the showings are for purposes of illustrating preferred embodiments of the present invention only, and not for purposes of limiting the same, a preferred embodiment of a liquid container 10 including a liquid container housing 12 and an illuminating handle 14 is depicted in FIGS. 1-7. The handle 14 includes a handle housing 16, a light source 18, an electrical lighting apparatus 19, a switch 20, and an attachment mechanism 22. Preferably, the light source is a high intensity LED.

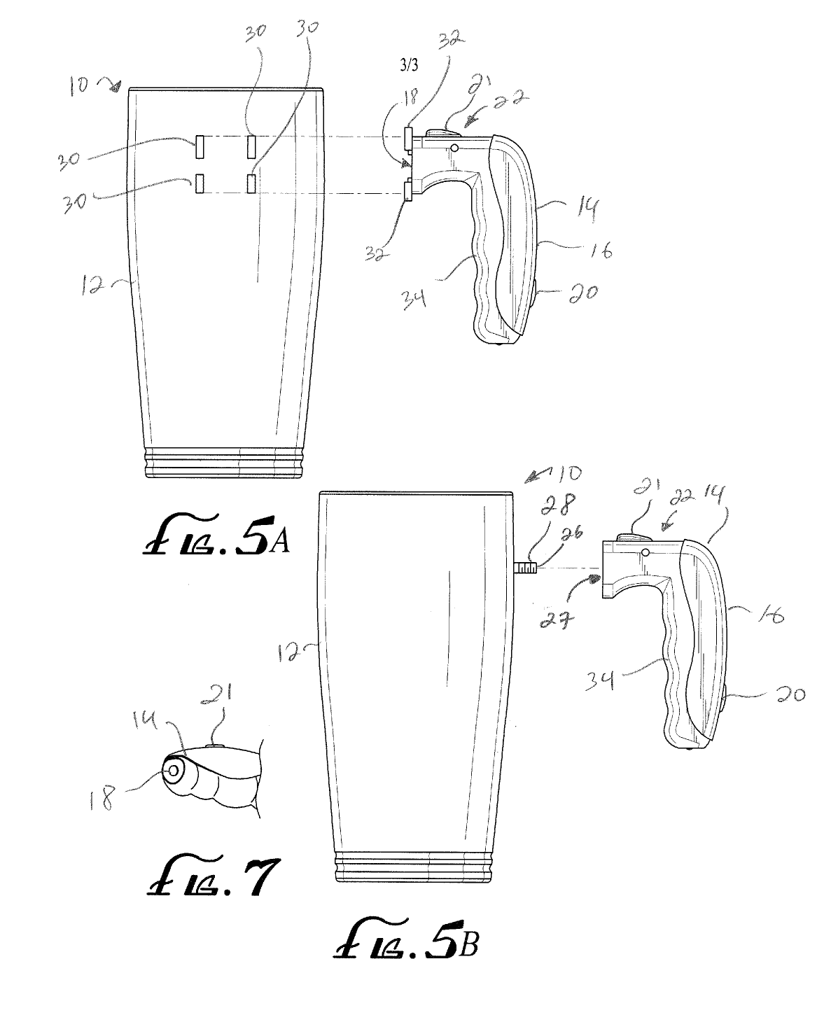

Preferably, the light source 18 is oriented within the housing such that when the handle 14 is removed from the container 10, the light source 18 may be activated via a switch 20 or 21. As shown in FIGS. 5A and 5B, the handle 14 may be formed having one or two switches 20 and 21. In this respect, switch 20 may be used exclusively for closing the electrical circuit while switch 21 is used exclusively to engage the handle 14 with the container housing 12. Alternatively, switch 21 may be configured such that sliding or depressing the switch into a first position simultaneously closes the electrical circuit to illuminate the light source 18 while disconnecting the attachment mechanism 22 from the container housing 12.

The electrical lighting apparatus includes an electrical circuit (not shown) and a power source (not shown). The electrical circuit is contained within the handle housing 16 and illuminates the light source 18 when the switch 20 is activated. There are a variety of available electrical circuits and the power sources available and well known to those skilled in the art. The power source can be a AAA battery, a button battery, or other alternative source of power well known to those skilled in the art. The power source can be contained in the handle housing 16.

Preferably, The light source 18 is embedded in the housing 16 at an upper end 24 of the handle 14. The light source 18 is oriented to direct light outwardly from the handle housing 16. The switch 20 is disposed near an upper end 26 of the handle 14. In a closed position, the switch 20 completes the electrical circuit to illuminate the light source 16. In an open position, the switch 20 turns off the light source 18 by temporarily disconnecting the electrical circuit from the power source.

Referring now to FIG. 5A, a first embodiment of the present invention is shown. The attachment mechanism 22 includes a plurality of tabs 32 extending from the handle housing 16 adjacent the light source 18. The container housing may then be formed with complementary recesses 30 that are configured to receive the tabs 32 therein. Switch 21 may be configured to retract or extend the tabs 32 via a spring-loaded mechanism (not shown) to allow for engagement of the handle 14 against the housing 12.

Referring now to FIG. 5B, a second embodiment of the present invention is shown. The attachment mechanism 22 includes a screw shaft 28 attached to and extending from the container housing 12 and a threaded opening 27 disposed in the handle housing 16. The handle 14 is attached to the container housing 12 by inserting the outer end 26 of the screw shaft 28 into the opening 30 and rotating the handle 14 in a clockwise direction until the handle 14 is snug against the container housing 12. The attachment mechanism 22 can be used to remove the handle 14 from the container housing 12 by rotating the handle 14 in a counter-clockwise direction several times. Thus, the attachment mechanism 22 is disposed between the container housing 12 and the handle 14 and can be attachable to, and removable from, the container housing 12 at solely one location. In this embodiment, the attachment mechanism 22 is disposed in the handle housing 12.

Referring now to FIGS. 1, 2, 5A and 5B, the handle housing 16 may be formed having a ergonomically shaped grip 34 that substantially fits the contours of a human hand.

Referring now to FIG. 7, an alternate embodiment of the handle 14 is shown that may be configured to engage the container housing via frictional fit or magnetics. For example, the container housing 12 may be formed having a recess for frictionally receiving the handle housing 16 or may be fitted with a magnetic portion to magnetically retaining the handle housing 16 against the container housing 12.

The embodiments of the present invention can also have advertising indicia 100, such as a trademark, service mark, trade name or logo, thereon. For example, such indicia can be located on the surface of the container housing 12 or the illuminating handle to create additional goodwill for a business.

The present invention also includes a method of advertising using a device according to the invention. Such an advertising method includes the step of preparing a liquid container or an illuminating handle according to the present invention. The term “preparing” is meant herein in a broad sense to include not only manufacturing but also acquiring from another source or selecting from available supplies.

A second step in the method of advertising could be placing advertising indicia 100 on an external surface of the illuminating handle 14 so that the indicia 100 are readily observable by persons in proximity to the device. The term “placing” is meant broadly to include not only physically putting the advertising indicia on the device's surface by, for example, imprinting, engraving, adhering, etc. the indicia. “Placing” also includes causing another person or company to place the indicia, or acquiring a device on which the advertising indicia were previously located.

One method of placing the advertising indicia could include the following sub-steps: (1) preparing a transparent advertising sheet; (2) disposing the advertising indicia between the transparent advertising sheet and the external surface of the container and holder; and (3) attaching the transparent sheet to the external surface, whereby the advertising indicia are displayed through the transparent sheet.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A liquid container having a handle for carrying the container, the container comprising:
a liquid container housing configured to selectively engage the handle;
the handle having
a hand-holdable handle housing,
a light source embedded within the handle housing and being oriented therewithin to direct light outwardly therefrom,
an electrical lighting apparatus including an electrical circuit and a power source electrically connected to the electrical circuit, the electrical circuit being enclosed within the handle housing, the lighting apparatus being configured to illuminate the light source when the circuit is closed,
a switch disposed on the handle housing and in electrical communication with the electrical circuit and positionable between first and second positions for selectively closing and opening the circuit respectively; and
an attachment mechanism configured to removably engage the liquid container housing at solely one location thereon.

2. The liquid container as in claim 1 wherein the attachment mechanism is disposed between the handle housing and the liquid container housing.

3. The liquid container as in claim 2 wherein the attachment mechanism includes a plurality of tabs extending from the handle housing, and the liquid container housing defines a plurality of recesses configured to receive the plurality of tabs therein and lockably engage the handle housing with the liquid container housing.

4. The liquid container as in claim 2 wherein the attachment mechanism includes a screw shaft extending from and attached to the liquid container housing, and the handle housing defines a threaded opening configured to matably receive the screw shaft therein for threadably engaging the handle housing with the liquid container housing.

5. The liquid container as in claim 2 wherein the switch is in mechanical communication with the attachment mechanism and simultaneously closes the circuit to illuminate the light source and disengages the attachment mechanism from the liquid container housing when the switch is placed in a first position.

6. The liquid container as in claim 5 wherein the switch simultaneously opens the circuit to disconnect power from the light source and engages the attachment mechanism to the liquid container housing when the switch is placed in a second position.

7. The liquid container as in claim 6 wherein the handle housing has a substantially L-shaped configuration.

8. A liquid container having a handle for carrying the container, the container comprising:
a liquid container housing configured to selectively engage the handle;
the handle having
a hand-holdable handle housing,
a light source embedded within the handle housing and being oriented therewithin to direct light outwardly therefrom when the handle housing is disengaged from the liquid container housing,
an electrical lighting apparatus including an electrical circuit and a power source electrically connected to the circuitry, the electrical circuit being enclosed within the handle housing, the lighting apparatus being configured to illuminate the light source when the circuit is closed,
a switch disposed on the handle housing and placed in electrical communication with the electrical circuit and positionable between first and second positions for selectively closing and opening the circuit respectively; and
an attachment mechanism disposed adjacent the light source, the attachment mechanism being configured to removably engage the liquid container housing and to substantially conceal the light source when connected thereto.

9. The liquid container as in claim 8 wherein the attachment mechanism is disposed between the handle housing and the liquid container housing.

10. The liquid container as in claim 9 wherein the attachment mechanism includes a plurality of tabs extending from the handle housing, and the liquid container housing defines a plurality of recesses configured to receive the plurality of tabs therein and lockably engage the handle housing with the liquid container housing.

11. The liquid container as in claim 9 wherein the attachment mechanism includes a screw shaft extending from and attached to the liquid container housing, and the handle housing defines a threaded opening configured to matably receive the screw shaft therein for threadably engaging the handle housing with the liquid container housing.

12. The liquid container as in claim 9 wherein the switch is in mechanical communication with the attachment mechanism and simultaneously closes the circuit to illuminate the light source and disengages the attachment mechanism from the liquid container housing when the switch is placed in a first position.

13. The liquid container as in claim 12 wherein the switch simultaneously opens the circuit to disconnect power from the light source and engages the attachment mechanism to the liquid container housing when the switch is placed in a second position.

14. The liquid container as in claim 6 wherein the handle housing has a substantially L-shaped configuration.

15. A method of advertising comprising the steps of:
(a) preparing a liquid container having a handle for carrying the container, the container comprising:
a liquid container housing configured to selectively engage the handle;
the handle having
a hand-holdable handle housing,
a light source embedded within the handle housing and being oriented therewithin to direct light outwardly therefrom,
an electrical lighting apparatus including an electrical circuit and a power source electrically connected to the electrical circuit, the electrical circuit being enclosed within the handle housing, the lighting apparatus being configured to illuminate the light source when the circuit is closed,
a switch disposed on the handle housing and in electrical communication with the electrical circuit and positionable between first and second positions for selectively closing and opening the circuit respectively, and
an attachment mechanism configured to removably engage the liquid container housing at solely one location thereon; and
(b) placing advertising indicia on an external surface of the liquid container so that the indicia are readily observable by a person in proximity to the liquid container.
